(19) United States
(12) Patent Application Publication
(10) Pub. No.: US 2024/0207931 A1
(43) Pub. Date: Jun. 27, 2024

(54) PRODUCTION PROCESS OF ALUMINUM SHEET SINTERED NICKEL LAYER

(71) Applicant: Taicang Manaflex Technology Co., Ltd., Taicang City (CN)

(72) Inventor: Robert C. Lane, Las Vegas, NV (US)

(21) Appl. No.: 18/390,845

(22) Filed: Dec. 20, 2023

(30) Foreign Application Priority Data
Dec. 21, 2022 (CN) 202211647708.7

(51) Int. Cl. B22F 7/04; B22F 3/105

(52) U.S. Cl. CPC B22F 7/04; B22F 3/105; B22F 2301/15; B22F 2303/20

(57) ABSTRACT

The invention discloses a production process of aluminum sheet sintered nickel layer, which comprises the following steps: S1, blending nickel paste: mixing nanometer nickel powder, resin and binder evenly to obtain nickel paste; S2, coating nickel paste: the nickel paste obtained by S1 is evenly coated on the surface of the aluminum sheet through the screen printing process; S3, primary sintering: the laser is used to heat the aluminum sheet coated with nickel paste at a continuous power of 15 W to 250 W; S4, secondary sintering: the use of laser to 200W to 500W continuous power to heat the aluminum coated with nickel paste again, the preparation of aluminum with nickel layer, can be directly completed tin, expand the scope of application of aluminum.

### CROSS REFERENCE TO RELATED APPLICATION

This application claims the benefit of and priority under 35 U.S.C. § 119 to Chinese Utility Model Application No. 202211647708.7 filed on Dec. 21, 2022, the entire contents of which are hereby incorporated by reference for all purposes.

### TECHNICAL FIELD

The invention relates to the technical field of aluminum sheet welding, in particular to a production process of aluminum sheet sintered nickel layer.

### BACKGROUND

At present, the soldering of aluminum foil in the vehicle FPC (Flexible Printed Circuit) needs to use nickel-plated aluminum, but the soldering position is often only a small local range. The production process of nickel-plated aluminum determines that nickel-plated aluminum cannot be locally nickel-plated on the whole raw material, and can only be nickel-plated as a whole. This causes a great waste of resources and increases the production cost.

In addition, the existing electroless plating process is the main process method for producing nickel-plated aluminum. It is a method of reducing metal ions into metal and depositing them on the surface of various materials to form a dense coating by using a strengthening reducing agent in a solution containing metal ions. Electroless nickel plating process is a kind of surface treatment process with high pollution, high energy consumption and low efficiency. At the same time, due to the poor flexibility of the process and low efficiency, it is not conducive to the application of high-tech fully automated production line.

### SUMMARY

In order to overcome the above shortcomings, the invention aims to provide a production process of aluminum sheet sintered nickel layer, and prepare aluminum sheet with nickel layer, which can be directly used on tin and tin welding.

In order to achieve the above purposes, the technical scheme of the invention is as follows:

The invention relates to a production process of aluminum sheet sintered nickel layer, including the following steps:
S1. Preparation of nickel paste: nanometer nickel powder and resin and binder mixed evenly to obtain nickel paste;
S2. Smear nickel paste: the nickel paste obtained from S1 is evenly smeared on the surface of the aluminum sheet through the screen printing process;
S3. Primary sintering: the laser is used to heat the aluminum sheet coated with nickel paste at a continuous power of 15 W to 250 W, leaving nano nickel powder covered in the aluminum sheet;
S4. Secondary sintering: using the laser at a continuous power of 200 W to 500 W to reapply the nanometer nickel powder aluminum sheet surface.

Further, in the production process of the sintered nickel layer of the aluminum sheet, the content of nanometer nickel powder in the nickel pulp exceeds 50%.

Further, in the production process of the sintered nickel layer of the aluminum sheet, the coating thickness of the nickel paste is 0.1˜0.3 mm.

Further, in the production process of the sintered nickel layer of the aluminum sheet, the laser is a CO2 laser or a fiber laser.

Further, in the production process of the sintered nickel layer of the aluminum sheet, step S3, the defocus of the laser is +2˜+8 mm, the galvanoscope speed is 200˜1500 mm/s, and the image line filling interval is 0.07˜0.3 mm.

Further, in the production process of the sintered nickel layer of the aluminum sheet, step S3, the power of the laser is 200 W, the defocusing amount is +5 mm, the galvanometer speed is 900 mm/s, and the image linear filling interval is 0.15 mm.

Further, in the production process of the sintered nickel layer of the aluminum sheet, step S3, the heating temperature of the nickel paste is 250˜550° C.

Further, in the production process of the sintered nickel layer of the aluminum sheet, step S4, the defocus of the laser is +1˜+7 mm, the galvanoscope speed is 150˜350 mm/s, and the image line filling interval is 0.06˜0.2 mm.

Further, in the production process of the sintered nickel layer of the aluminum sheet, step S4, the power of the laser is 300 W, the defocusing amount is +5.5 mm, the galvanometer speed is 250 mm/s, and the image linear filling interval is 0.15 mm.

Further, in the production process of the sintered nickel layer of the aluminum sheet, step S3, the heating temperature of the nickel paste exceeds 1453° C.

The beneficial effects of the invention are:
(1) The laser sintering process is based on laser equipment as the carrier, has a high degree of flexibility and automation, and is very conducive to integration into the fully automated production line;
(2) laser sintering process has low pollution, low energy consumption, high efficiency, saving a lot of production costs and social resources; and
(3) Compared with copper, aluminum is lighter in density and lower in cost. The aluminum sheet with nickel layer can be directly completed on the tin, which will promote the application of aluminum in the new energy industry, and is of great significance to reduce the industry cost.

### DETAILED DESCRIPTION

### Specific Implementations

The best implementations of the invention are described in detail below, so that the advantages and characteristics of the invention can be more easily understood by persons skilled in the art, and the scope of protection of the invention can be more clearly defined.

### Implementation 1

A production process for aluminum sheet sintered nickel layer comprises the following steps:
S1. Preparation of nickel paste: nanometer nickel powder (CAS login number: 7440-02-0), resin and binder mix evenly to obtain nickel paste, of which, nanometer nickel powder more than 50%, resin and binder can be purchased;
S2. Smear nickel paste: the nickel paste obtained from S1 is evenly smeared on the surface of the aluminum sheet through the screen printing process, the thickness of the nickel paste is 0.1˜0.3 mm, among which, the nickel paste can be smeared locally or as a whole, according to the actual need for the location of the solder welding connection can be silkscreen printing;
S3. Primary sintering: The CO₂ laser or fiber laser is used to irradiate the aluminum sheet coated with nickel paste at a continuous power of 15 W to 250 W. Laser using +2˜+8 mm defocusing or multi-mode spot, so that the laser can heat the resin and binder in the nickel paste, the galvanic speed is set between 200 mm/s to 1500 mm/s, the image line filling interval is between 0.07 mm and 0.3 mm, and the temperature is controlled at 250° C. to 550° C. The resin and other non-metallic components in the nickel paste will be rapidly decomposed and volatilized, and the melting point of nickel is above 1453° C., and finally the nano-nickel powder is covered in the aluminum surface; and
S4. Secondary sintering: Again use CO₂ laser or fiber laser to 200 W to 500 W continuous power irradiate aluminum surface with nanometer nickel powder, in order to make the heating temperature quickly rise to the melting point of nickel 1453° C. above, laser defocus is +1˜+7 mm, can obtain relatively high energy density, in addition, aluminum melting point is only 660° ° C., far lower than the melting point of nickel. In order to avoid high temperature heating caused by large deformation of the aluminum sheet, the galvanoscope speed is set at 150 mm/s to 350 mm/s, the image linear filling interval of 0.06 mm to 0.2 mm, the temperature of the nanometer nickel powder on the surface of the aluminum sheet rapidly rises above the melting point of nickel, and from the upper layer of nanometer nickel powder to the aluminum sheet, so that the two together liquefied, the laser swept after rapid cooling and solidification. After remelting a layer of nickel on the surface of the aluminum sheet.

Through the nickel layer on the surface of the aluminum sheet, the aluminum sheet can be easily tinned.

### Implementation 2

A production process for aluminum sheet sintered nickel layer comprises the following steps:
S1. Preparation of nickel paste: nanometer nickel powder (CAS login number: 7440-02-0), resin and binder mixed evenly to obtain nickel paste, of which, nanometer nickel powder more than 50%;
S2. Smear nickel paste: the nickel paste obtained from S1 is evenly smeared on the surface of the aluminum sheet through the screen printing process, the thickness of nickel paste is 0.2 mm, among which, nickel paste can be smeared locally or as a whole;
S3. Primary sintering: CO₂ laser or fiber laser to 200 W continuous power irradiate nickel paste coated aluminum sheet; laser using +5 mm defocus or multi-mode spot, so that the laser can heat the resin and binder in the nickel paste, galvanic speed is set at 900 mm/s, image linear filling interval of 0.15 mm, and the temperature is controlled at about 500° C., the resin and other non-metallic components in the nickel paste will be rapidly decomposed and volatilized, and the melting point of nickel above 1453° C.; and finally, the nano-nickel powder is left covered in the aluminum surface; and
S4. Secondary sintering: The CO₂ laser or fiber laser is used again to irradiate the aluminum surface with nanometer nickel powder with a continuous power of 300 W, in order to make the heating temperature rise rapidly to the melting point of nickel above 1453° C., the laser uses a defocus of +5.5 mm, which can obtain a relatively high energy density, in addition, the melting point of aluminum is only 660° C., far lower than the melting point of nickel. In order to avoid high temperature heating caused by large deformation of the aluminum sheet, the galvanic speed is set at 250 mm/s, the image linear filling interval is 0.15 mm, the temperature of the nanometer nickel powder on the surface of the aluminum sheet rapidly rises above the melting point of nickel, and the nano nickel powder from the upper layer is transmitted to the aluminum sheet, so that the two are liquefied together, and the laser is quickly cooled and solidified after sweeping. After remelting a layer of nickel on the surface of the aluminum sheet.

The production process described in Implementations 1 and 2 is based on laser equipment, which is highly flexible and automated, and is very conducive to integration into a fully automated production line. In addition, the laser sintering process has low pollution, low energy consumption, high efficiency, saving a lot of production costs and social resources. Moreover, compared with copper, the density of metal aluminum is lighter and the cost is lower. The aluminum sheet with nickel layer can be directly completed on the tin, which will promote the application of aluminum in the new energy industry and is of great significance to reduce the industry cost.

The above implementation is only to illustrate the technical idea and characteristics of the invention, and its purpose is to let the person familiar with the technology understand the content of the invention and implement it, and cannot limit the scope of protection of the invention. All equivalent changes or modifications made according to the spirit of the invention shall be covered within the scope of protection of the invention.

1. A production process of aluminum sheet sintered nickel layer comprising the following steps:
S1. Allocation of nickel pulp: a nano nickel powder and a resin and a binder are mixed evenly, making a nickel pulp;
S2. Smear nickel paste: a nickel paste obtained from step S1 is evenly smeared on a surface of an aluminum sheet through a screen printing process;
S3. Primary sintering: a laser is used to heat the aluminum sheet coated with nickel paste at a continuous power of 15 W to 250 W, leaving nano nickel powder covered on the aluminum sheet; and
S4. Secondary sintering: using the laser at a continuous power of 200 W to 500 W to reapply a nanometer nickel powder aluminum sheet surface.

2. The production process according to claim 1, wherein a content of nanometer nickel powder in the nickel pulp exceeds 50%.

3. The production process according to claim 1, wherein a coating thickness of the nickel paste is 0.1˜0.3 mm.

4. The production process according to claim 1, wherein the laser is characterized by a CO₂ laser or a fiber laser.

5. The production process according to claim 1, wherein in step S3, a defocus of the laser is +2˜+8 mm, a galvanometer speed is 200˜1500 mm/s, and an image line filling interval is 0.07˜0.3 mm.

6. The production process according to claim 5, wherein in step S3, the power of the laser is 200 W, the defocus of the laser is +5 mm, the galvanometer speed is 900 mm/s, and the image line filling interval is 0.15 mm.

7. The production process according to claim 1, wherein a heating temperature of the nickel paste in step S3 is 250˜550° ° C.

8. The production process according to claim 1, wherein in step S4, a defocusing amount of the laser is +1˜+7 mm, a galvanometric speed is 150˜350 mm/s, and an image line filling interval is 0.06˜0.2 mm.

9. The production process according to claim 8, wherein in step S4, the power of the laser is 300 W, the defocusing amount is +5.5 mm, the galvanometric speed is 250 mm/s, and the image line filling interval is 0.15 mm.

10. The production process according to claim 1, wherein in step S3, a heating temperature of nickel paste exceeds 1453° C.
